(19) United States
(12) Patent Application Publication
(10) Pub. No.: US 2011/0289007 A1
(43) Pub. Date: Nov. 24, 2011

(54) NEGOTIABLE SENSITIVE USER DATA MANAGEMENT METHOD AND SYSTEM

(75) Inventors: Bharath Duggirala, Bangalore (IN); Krishna C. Kumar, Tamil Nadu (IN); Murthy V. Rallapalli, Alpharetta, GA (US); Kamalakanth Satuluru, Suwanee, GA (US)

(73) Assignee: International Business Machines Corporation, Armonk, NY (US)

(21) Appl. No.: 12/781,938

(22) Filed: May 18, 2010

(51) Int. Cl. G06Q 30/00; G06Q 10/00; G06Q 99/00; G06Q 20/00

(52) U.S. Cl. 705/80; 705/27.1

(57) ABSTRACT

A sensitive user data management method and system. The method includes presenting, by a negotiable content sensitive user data service (NSUDS) computing system from a consumer accessing a consumer computer in communication with a service provider computing system, a request for verifying if a provider computing system is associated with an NSUDS registry. The NSUDS computing system verifies an association with the NSUDS registry and connects to the consumer computer. The NSUDS computing system presents default sensitive user terms associated with sensitive user data for the consumer. The sensitive user data is associated with an order request. The NSUDS computing system receives from the consumer in response to the default sensitive user terms, a command associated with the default sensitive user terms.

### FIELD OF THE INVENTION

The present invention relates to a method and associated system for managing sensitive user data.

### BACKGROUND OF THE INVENTION

Providing a trusted source for securing information typically comprises an inefficient process with little flexibility. A single entity is typically used for securing and usage of information. Using a single entity for securing and usage of information may result in a breach of the information.

### SUMMARY OF THE INVENTION

The present invention provides a method comprising: receiving, by a computer processor of a negotiable sensitive user data service (NSUDS) computing system from a consumer accessing a consumer computer, a request for verifying if a service provider computing system is associated with an NSUDS registry, wherein the consumer computer is communicating with the service provider computing system, wherein the consumer computer transmits an order request to the service provider computing system, wherein the NSUDS computing system is independent from the service provider computing system and the consumer computer; verifying, by the computer processor in response to the request, that the service provider computing system is associated with the NSUDS registry; connecting, by the computer processor in response to results of the verifying, the NSUDS computing system to the consumer computer; presenting, by the computer processor in response to the connecting, default sensitive user terms associated with sensitive user data for the consumer, wherein the sensitive user data is associated with the order request; and receiving, by the computer processor from the consumer in response to the default sensitive user terms, a command associated with the default sensitive user terms.

The present invention provides a negotiable content sensitive user data service (NSUDS) computing system comprising a computer processor coupled to a computer-readable memory unit, the memory unit comprising instructions that when enabled by the computer processor implement a method, the method comprising: receiving, by the computer processor from a consumer accessing a consumer computer, a request for verifying if a service provider computing system is associated with an NSUDS registry, wherein the consumer computer is communicating with the service provider computing system, wherein the consumer computer transmits an order request to the service provider computing system, wherein the NSUDS computing system is independent from the service provider computing system and the consumer computer; verifying, by the computer processor in response to the request, that the service provider computing system is associated with the NSUDS registry; connecting, by the computer processor in response to results of the verifying, the NSUDS computing system to the consumer computer; presenting, by the computer processor in response to the connecting, default sensitive user terms associated with sensitive user data for the consumer, wherein the sensitive user data is associated with the order request; and receiving, by the computer processor from the consumer in response to the default sensitive user terms, a command associated with the default sensitive user terms.

The present invention advantageously provides a simple method and associated system capable of providing a trusted source for securing information.

### BRIEF DESCRIPTION OF THE DRAWINGS

FIG. 1 illustrates a system for managing and protecting consumer sensitive user information, in accordance with embodiments of the present invention

FIG. 2 illustrates a flowchart describing an algorithm used by the system of FIG. 1 for managing and protecting sensitive user information, in accordance with embodiments of the present invention.

FIG. 3A illustrates a screen shot enabled by the system of FIG. 1 for verifying that a service provider computing system is associated with an NSUDS registry, in accordance with embodiments of the present invention.

FIG. 3B illustrates a populated screen shot associated with the screen shot of FIG. 3A, in accordance with embodiments of the present invention.

FIG. 3C illustrates a screen shot enabled by the system of FIG. 1 for creating an order, in accordance with embodiments of the present invention.

FIG. 3D illustrates a screen shot enabled by the system 5 of FIG. 1 for displaying default sensitive user terms associated with sensitive user data, in accordance with embodiments of the present invention.

FIG. 3E illustrates a screen shot enabled by the system 5 of FIG. 1 for allowing a user to modify default sensitive user terms, in accordance with embodiments of the present invention.

FIG. 3F illustrates a screen shot enabled by the system 5 of FIG. 1 for illustrating sensitive user terms that are maintained by an NSUDS computing system, in accordance with embodiments of the present invention.

FIG. 3G illustrates a screen shot enabled by the system of FIG. 1 for illustrating a sensitive user data maintenance notification transmitted to a consumer, in accordance with embodiments of the present invention.

FIG. 4 illustrates a computer apparatus used for managing and protecting sensitive user information, in accordance with embodiments of the present invention.

### DETAILED DESCRIPTION OF THE INVENTION

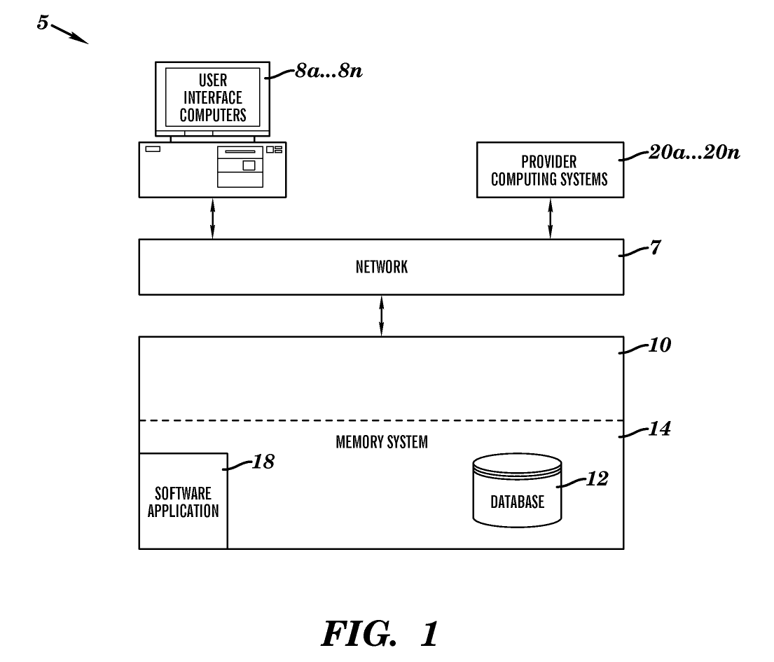

FIG. 1 illustrates a system 5 for managing and protecting sensitive user information, in accordance with embodiments of the present invention. System 5 comprises a negotiable sensitive user data service (NSUDS) computing system 10 that comprises components that allow websites (i.e., providing goods or services) to leverage e-commerce transactions with effective sensitive user data containment. NSUDS computing system 10 enables a process for protecting and managing a consumer's sensitive user data (e.g., credit card/banking information, customer address or telephone number, social security number, drivers license number, etc) used during a transaction (e.g., during a sale). Consumer sensitive user data may be protected to protect a user from many sensitive user data appropriation issues including, inter alia, identity appropriation, improper dissemination of data, account appropriation, etc. NSUDS computing system 10 comprises an independent system (i.e., from service or product providers using provider computing systems 20a . . . 20n) for protecting the sensitive user data thereby obviating a need for a service/product provider from protecting the sensitive user data. NSUDS computing system 10 intelligently streamlines the data between trusted agency and the service provider. NSUDS computing system 10 performs the following functions associated with maintaining and modifying customer sensitive user data:

1. NSUDS computing system 10 manages a schedule for purging sensitive user data upon an expiration of a sensitive user term as dictated by a web consumer.
2. NSUDS computing system 10 notifies consumers when sensitive user terms are maintained.
3. NSUDS computing system 10 provides a general framework for separating sensitive user data separation from a service/product provider.
4. NSUDS computing system 10 intelligently delineates data streams and provides a separation of sensitive user data enablement and purging.
5. NSUDS computing system 10 handles the sensitive user data while a service/product provider handles an e-commerce portion of a transaction (e.g., a sale portion).

System 5 of FIG. 1 comprises provider computing systems 20a . . . 20n and user interface computers 8a . . . 8n connected through a network 7 to NSUDS computing system 10. Provider computing systems 20a . . . 20n comprise systems used by product and/or service providers for providing a means (e.g., a Website) for conducting a sale for a product and/or service. During a user transaction (e.g., during a product or service sale), user interface computers 8a . . . 8n retrieve (from users) sales information (e.g., product selection) and sensitive user data associated with the sales information (e.g., credit card number and security code). User interface computers 8a . . . 8n communicate the sales information directly (via network 7) to provider computing systems 20a . . . 20n. Likewise, user interface computers 8a . . . 8n communicate the sensitive user data (via network 7) to NSUDS computing system 10 for processing and NSUDS computing system 10 performs any transactions using the sensitive user data so that the sensitive user data is protected from viewing via provider computing systems 20a . . . 20n. Network 7 may comprise any type of network including, inter alia, a local area network, (LAN), a wide area network (WAN), the Internet, etc. User interface computing devices 8a . . . 8n may comprise any type of computing apparatus including, inter alia, a personal computer (PC), a laptop computer, a computer terminal, etc. Provider computing systems 20a . . . 20n may comprise any type of computing system(s) including, inter alia, a personal computer (PC), a server computer, a database computer, etc. NSUDS computing system 10 may comprise any type of computing system(s) including, inter alia, a personal computer (PC), a server computer, a database computer, etc. NSUDS computing system 10 comprises a memory system 14. Memory system 14 may comprise a single memory system. Alternatively, memory system 14 may comprise a plurality of memory systems. Memory system 14 comprises a software application 18 and a database 12. Database 12 may comprise multiple databases. Database 12 comprises all retrieved sensitive user data (i.e., retrieved from user interface computing devices 8a . . . 8n). Software application 18 controls functionality associated with managing and protecting consumer sensitive user data. Additionally (i.e., in addition to software application 18), system 5 may comprise a high speed appliance/software filter/network component enabler that may be injected into a vendor's network upon a business agreement with a trust agency. The high speed appliance/software filter/network component enabler may act as an agent of a trust agency thereby intercepting client requests. Within the high speed appliance/software filter/network component enabler, client requests are parsed and rewritten replacing sensitive user information with symbolic pointers to refer actual information. The rewritten requests are forwarded to a vendor system for order processing. The sensitive user data and sensitive user terms are forwarded to a trust agency through a secured web service to be processed and stored in an agency database.

NSUDS computing system 10 enables a retention and management process for managing user sensitive user data used for completing an e-commerce transaction. Based on set of criteria of an operating environment (e.g., government, regulatory, legal, vendor, client, technology etc) transaction type, e-commerce vendors/companies (e.g., via provider computing systems 20a . . . 20n) are required to gather specified sensitive user data (sensitive user terms) from their clients. NSUDS computing system 10 retrieves the user sensitive user data in order to:

1. Present (i.e., to e-commerce clients) sensitive user terms and enable an opportunity for e-commerce clients to express specified preferences regarding the sensitive user data by overriding the sensitive user terms.
2. Promote a negotiation process (associated with the sensitive user terms) between the e-commerce clients and the e-commerce vendors/companies.
3. Establish a trust environment by engaging an authorized trust agency and entrust the sensitive user data management responsibilities to a third party agency. Additionally, NSUDS computing system 10 enables a high speed filter acting as an agent of a trust agency which intercepts client requests (i.e., associated with a transaction or sale). The client requests are parsed and rewritten thereby replacing sensitive user data with symbolic pointers that refer actual information. The rewritten requests are forwarded to the vendor systems (e.g., provider computing systems 20a . . . 20n) for order processing. The sensitive user data and sensitive user terms are forwarded to NSUDS computing system 10 through a secured Web service to be processed and stored in database 12. Additionally, NSUDS computing system 10 establishes a sensitive user transaction with e-commerce clients by providing special headers recognized by Web browsers thereby guarantying that the vendors are bound by an NSUDS agency agreement. The trust agency (i.e., via NSUDS computing system 10 in the form of secured web services) provides the following services:
1. Service provider or vendor registry services (e.g., add, delete, change, search vendors, etc).
2. Sensitive user data hosting and retrieval services (e.g., digital escrow).
3. Negotiation services.
4. Trust enforcement services to fulfill negotiated terms.
5. Communication services to update the status of sensitive user data to interested parties.

NSUDS computing system 10 enables a process comprising mutual negotiations between a Web user (e.g., a consumer) and a service provider (e.g., e-commerce vendors/companies) as to how long the service provider will retain (store) the web consumer's sensitive user data. A time period for retaining (i.e., by the service provider) the Web consumer's sensitive user data (e.g., credit card number, social security number, drivers license number etc) may be influenced by several factors such as, inter alia, a vendor preference, fulfillment requirements, environmental factors, government requirements, legal requirements etc. For example, a credit card number may have to be retained by a service provider for at least 30 days due to:

1. Environmental reasons—The credit card may comprise a foreign credit card requiring the credit card number to be held for 30 days.
2. Government regulations—Certain state or federal government regulations may require service providers to hold the credit card number for 2 years for various purposes.
3. Fulfillment requirements—If a purchased product is coming from another country, a longer lead time may be required and a service provider may want to retain a credit card number for a longer time period.
4. Service provider preference—A vendor may want to retain a credit card number for longer than typical periods for business analytics or due to competition practices.

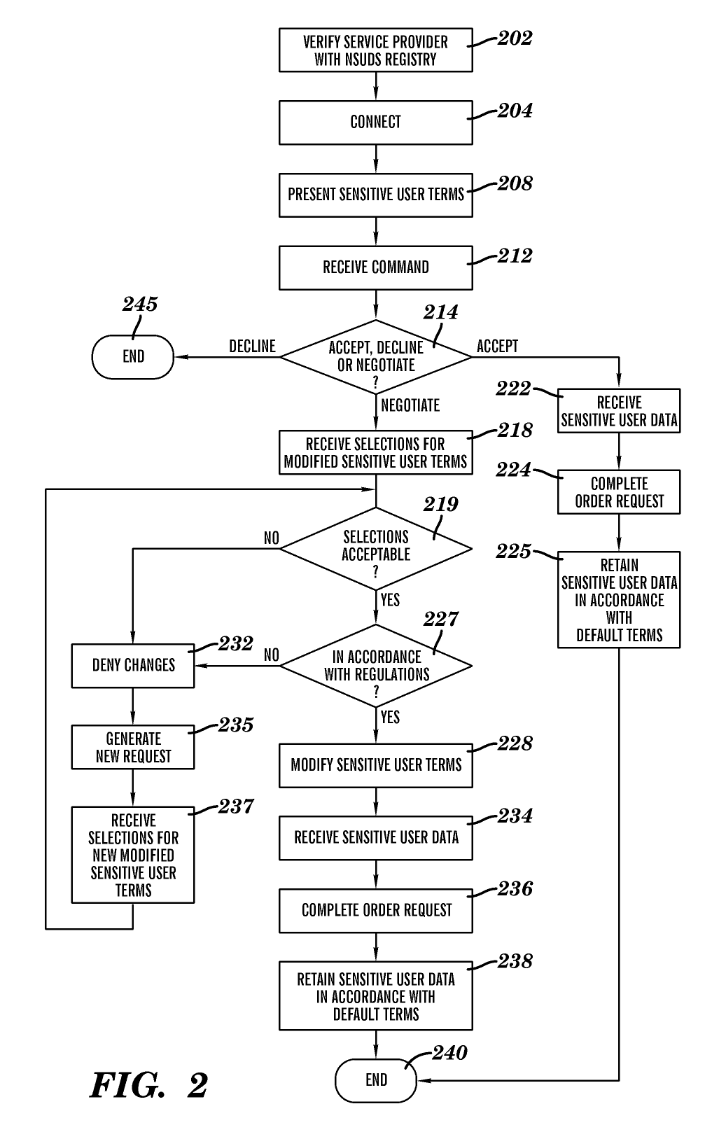

FIG. 2 illustrates a flowchart describing an algorithm used by system 5 of FIG. 1 for managing and protecting consumer sensitive user information, in accordance with embodiments of the present invention. In step 202, a computer processor of an NSUDS computing system (e.g., NSUDS computing system 10 of FIG. 1) receives (i.e., from a consumer accessing a consumer computer such as one of user interface computers 8a . . . 8n of FIG. 1) a request for verifying that a service provider computing system (e.g., one of provider computing systems 20a . . . 20n of FIG. 1) is associated with an NSUDS registry. During the process enabled in step 202, the consumer computer is in communication with the service provider computing system during a transaction (e.g., a sale). During the transaction, the consumer computer transmits an order request to the service provider computing system. In step 206, the computer processor connects (i.e., in response to results of the verifying process performed in step 202) the NSUDS computing system to the consumer computer. In step 208, the computer processor presents default sensitive user terms (e.g., retention time periods) associated with sensitive user data (e.g., a consumer name, a consumer address, a consumer telephone number, a consumer email address, a consumer credit card number, a consumer security code for the credit card number, a social security number, etc) for the consumer. The sensitive user data is associated with and used to process the order request. In step 212, the computer processor receives (i.e., from the consumer in response to the default sensitive user terms) a command associated with the default sensitive user terms. In step 214, it is determined if the consumer has accepted, declined, or would like to negotiate the default sensitive user terms.

If in step 214, it is determined that the consumer has declined the default sensitive user terms then the process is terminated in step 245.

If in step 214, it is determined that the consumer has accepted the default sensitive user terms then in step 222, the computer processor receives (i.e., from the consumer) the sensitive user data in accordance with the default sensitive user terms. In step 224, the computer processor transmits (i.e., to the service provider computing system) authorization (e.g., a payment and mailing address) for completing the order request resulting in a completed order for a product or service for the consumer. In step 225, the NSUDS computing system retains the sensitive user data in accordance with the default sensitive user terms and the process is terminated in step 240.

If in step 214, it is determined that the consumer would like to negotiate the default sensitive user terms then in step 218, the computer processor receives (i.e., in response to a negotiation command from the consumer) selections for modified sensitive user terms associated with the default sensitive user terms. In step 219, the computer processor determines (verifies) if the modified sensitive user terms are acceptable (e.g., in accordance with company regulations). The modified sensitive user terms may be determined to be acceptable/unacceptable by assigning the modified sensitive user terms a confidence factor. A confidence factor comprises a numeric computed empirical value that provides guidance to a Web consumer as to a sensitive user terms grading policy (e.g., should a user go ahead with a transaction).

If in step 219, the computer processor determines that the modified sensitive user terms are not acceptable (e.g., in accordance with company regulations) then in step 232, the computer processor denies changes to the default sensitive user terms (e.g., disabling the modified sensitive user terms). In step 235, the computer processor generates and transmits a new sensitive user terms request for the consumer. In step 237, the computer processor receives (from the consumer in response to the new sensitive user terms request) new selections for new modified sensitive user terms associated with the default sensitive user terms and step 227 is repeated to determine if the new selections for the new modified sensitive user terms are acceptable (e.g., in accordance with company regulations).

If in step 219, the computer processor determines (verifies) that the modified sensitive user terms are acceptable (e.g., in accordance with company regulations) then in step 227, the computer processor determines (verifies) if the modified sensitive user terms are in accordance with specified regulations (e.g., vendor preference regulations, fulfillment requirements regulations, environmental/legal regulations, government regulations, etc).

If in step 227, the computer processor determines that the modified sensitive user terms are in accordance with the specified regulations then in step 228, the computer processor modifies the default sensitive user terms in accordance with the selections for modified sensitive user terms from step 218. Modifying the default sensitive user terms may include replacing at least one of the default sensitive user terms with at least one of the modified sensitive user terms. In step 234, the computer processor receives (from the consumer) the sensitive user data. In step 236, the computer processor transmits (i.e., to the service provider computing system) authorization (e.g., a payment and mailing address) for completing the order request resulting in a completed order for a product or service for the consumer. In step 238, the NSUDS computing system retains the sensitive user data in accordance with the modified sensitive user terms and the process is terminated in step 240.

If in step 227, the computer processor determines that the modified sensitive user terms are not in accordance with the specified regulations then in step 232, the computer processor denies changes to the default sensitive user terms (e.g., disabling the modified sensitive user terms). In step 235, the computer processor generates and transmits a new sensitive user terms request for the consumer. In step 237, the computer processor receives (from the consumer in response to the new sensitive user terms request) new selections for new modified sensitive user terms associated with the default sensitive user terms and step 227 is repeated to determine if the new selections for the new modified sensitive user terms are in accordance with the specified regulations.

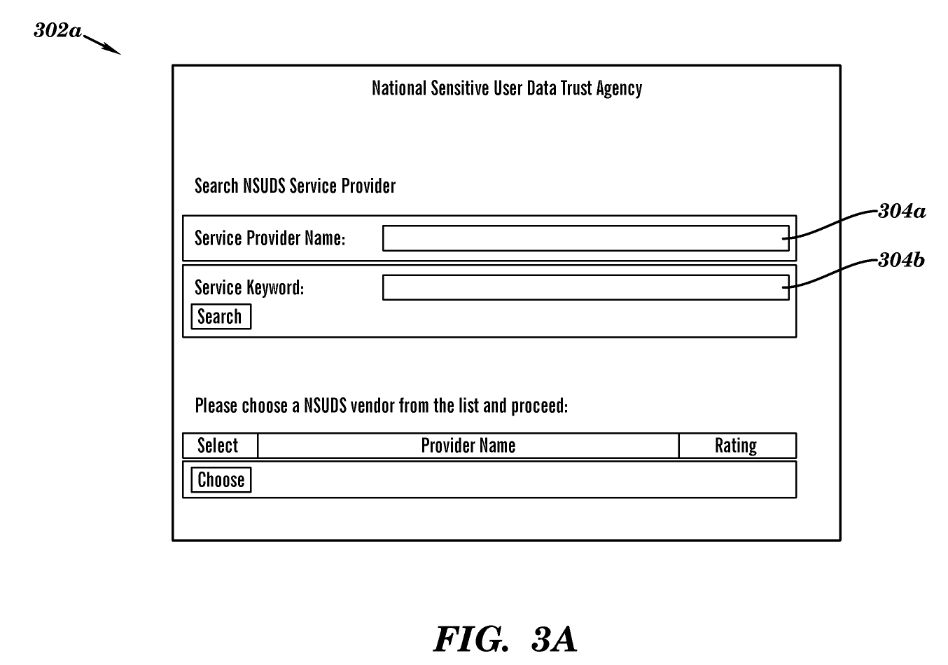

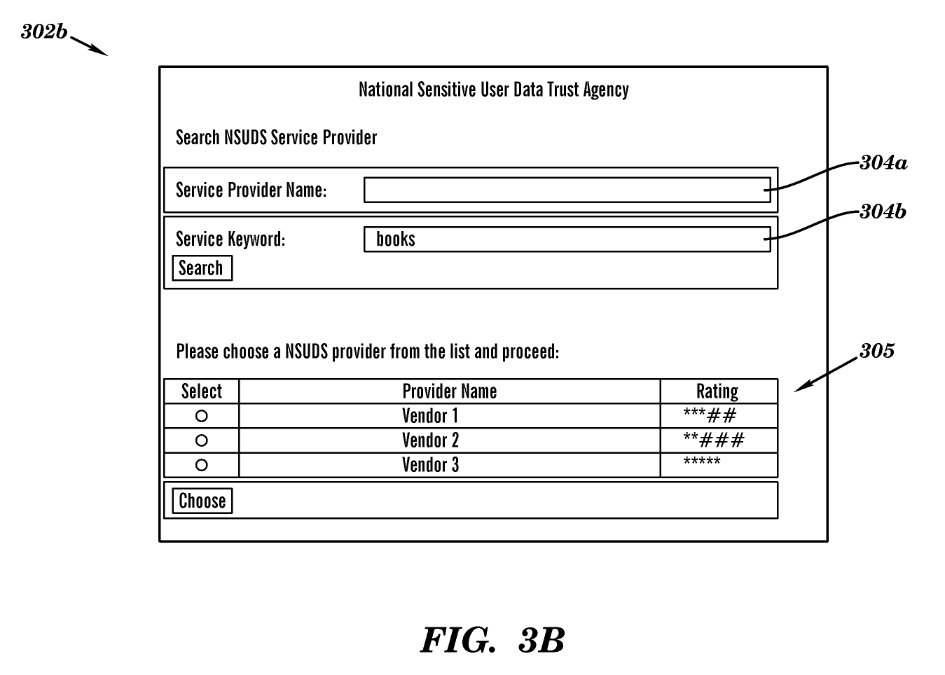

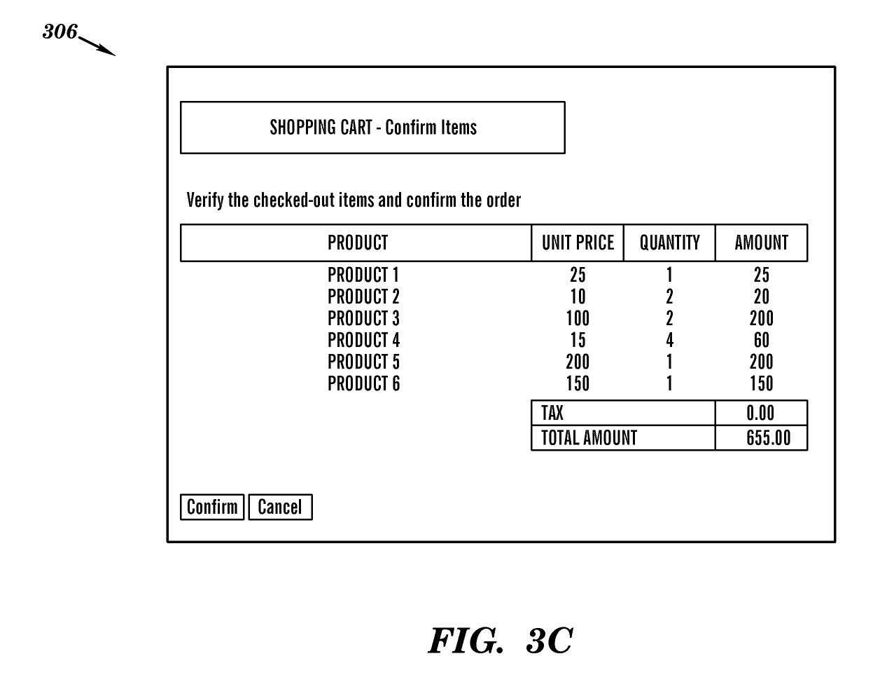

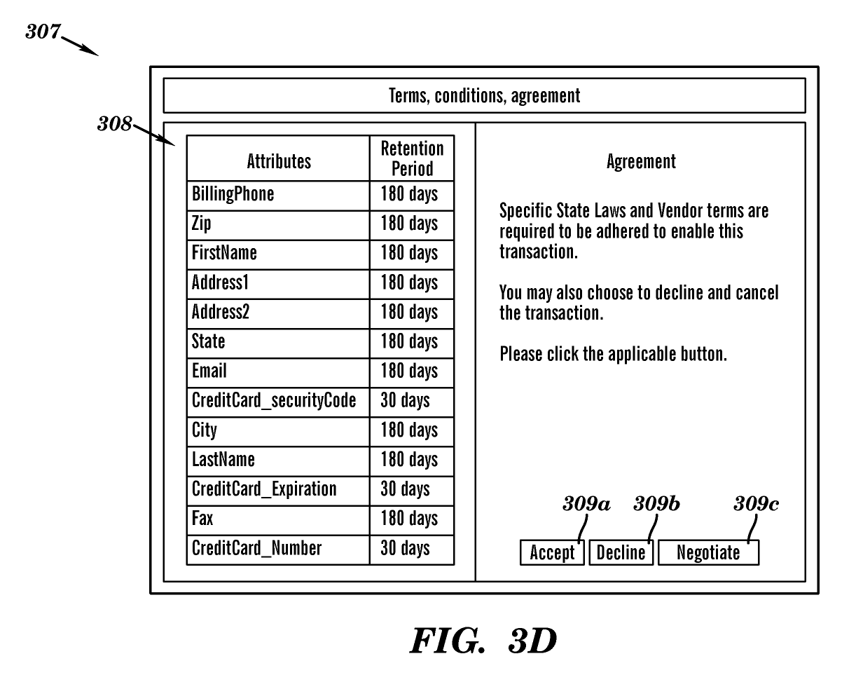

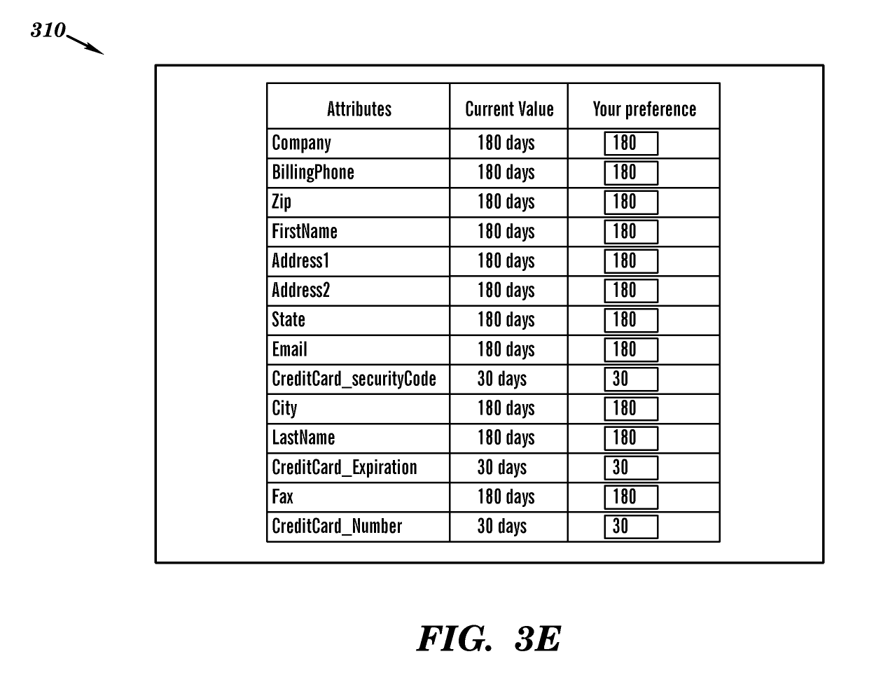

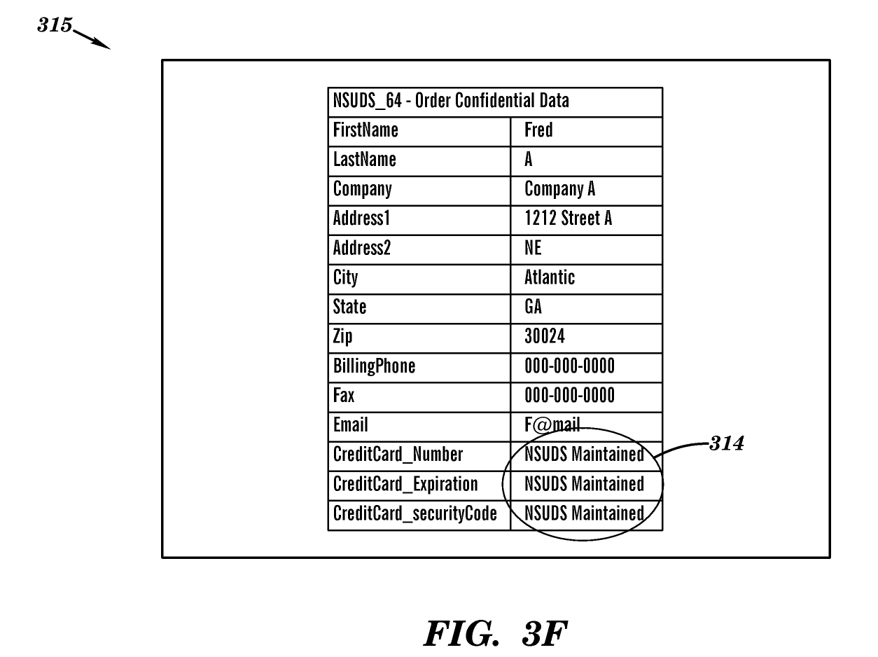

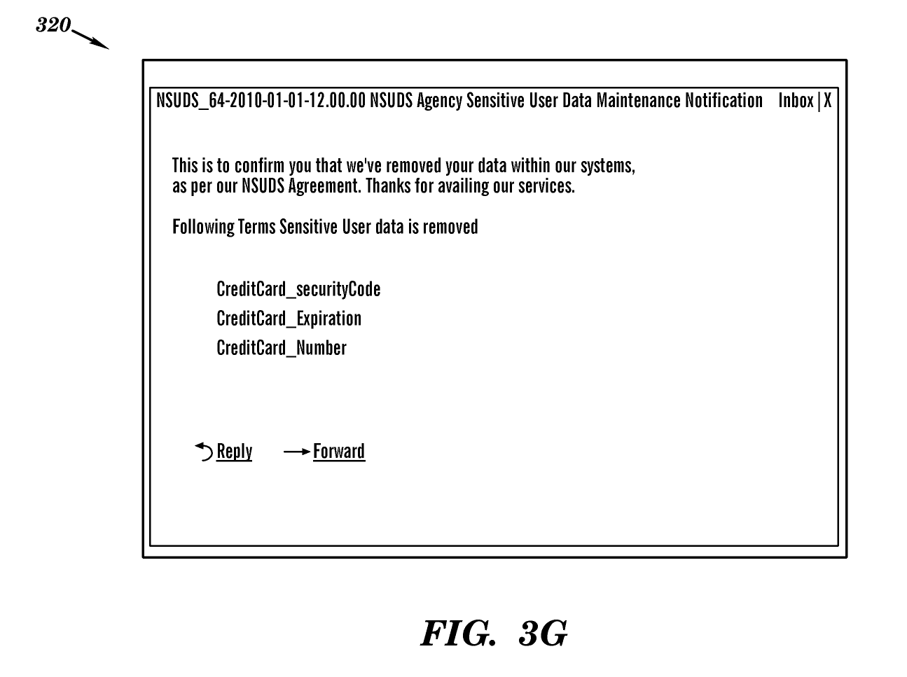

FIG. 3A illustrates a screen shot 302a enabled by system 5 of FIG. 1 for verifying that a service provider computing system (e.g., one of provider computing systems 20a . . . 20n of FIG. 1) is associated with an NSUDS registry, in accordance with embodiments of the present invention. Screen shot 302a allows a consumer to enter search terms in field 304a (i.e., using a service provider name) and 304b (i.e., using any key word).

FIG. 3B illustrates a populated screen shot 302b associated with screen shot 302a of FIG. 3A, in accordance with embodiments of the present invention. Screen shot 302b illustrates a field 305 comprising a list of providers associated with the NSUDS registry.

FIG. 3C illustrates a screen shot 306 enabled by system 5 of FIG. 1 for creating an order, in accordance with embodiments of the present invention.

FIG. 3D illustrates a screen shot 307 enabled by system 5 of FIG. 1 for displaying default sensitive user terms 308 associated with sensitive user data, in accordance with embodiments of the present invention. The default sensitive user terms 308 may be accepted (i.e., via an accept button 309a), declined (i.e., via a decline button 309b), or negotiated (i.e., via a negotiate button 309c).

FIG. 3E illustrates a screen shot 310 enabled by system 5 of FIG. 1 for allowing a user to modify default sensitive user terms 308 after enabling negotiate button 309c of FIG. 3D, in accordance with embodiments of the present invention.

FIG. 3F illustrates a screen shot 315 enabled by system 5 of FIG. 1 for illustrating sensitive user terms 314 that are maintained by NSUDS computing system 10, in accordance with embodiments of the present invention.

FIG. 3G illustrates a screen shot 320 enabled by system 5 of FIG. 1 for illustrating a sensitive user data maintenance notification transmitted to a consumer, in accordance with embodiments of the present invention.

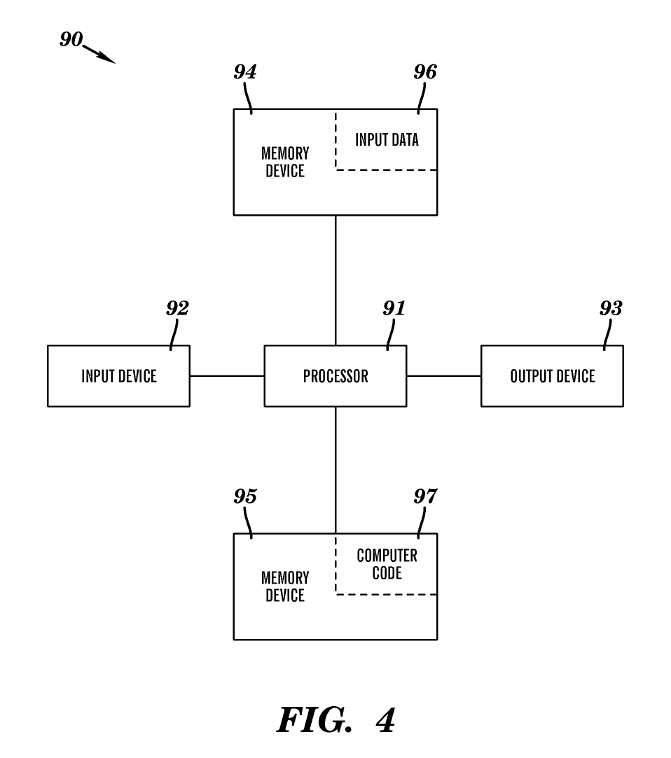

FIG. 4 illustrates a computer apparatus 90 (e.g., NSUDS computing system 10 of FIG. 1) used for managing and protecting sensitive user information, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a software application, a mouse, etc. The output device 93 may be, inter alia, a printer, a plotter, a computer screen, a magnetic tape, a removable hard disk, a floppy disk, a software application, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for managing and protecting consumer sensitive user information. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 4) may comprise the algorithm of FIG. 2 and may be used as a computer usable medium (or a computer readable medium or a program storage device) having a computer readable program code embodied therein and/or having other data stored therein, wherein the computer readable program code comprises the computer code 97.

Generally, a computer program product (or, alternatively, an article of manufacture) of the computer system 90 may comprise the computer usable medium (or the program storage device).

Still yet, any of the components of the present invention could be created, integrated, hosted, maintained, deployed, managed, serviced, etc. by a service provider who offers to for manage and protect sensitive user information. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for managing and protecting sensitive user information. In another embodiment, the invention provides a method that performs the process steps of the invention on a subscription, advertising, and/or fee basis. That is, a service provider, such as a Solution Integrator, could offer to manage and protect sensitive user information. In this case, the service provider can create, maintain, support, etc. a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 4 shows the computer system 90 as a particular configuration of hardware and software, any configuration of hardware and software, as would be known to a person of ordinary skill in the art, may be utilized for the purposes stated supra in conjunction with the particular computer system 90 of FIG. 3. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method comprising:
receiving, by a computer processor of a negotiable content sensitive user data service (NSUDS) computing system from a consumer accessing a consumer computer, a request for verifying if a service provider computing system is associated with an NSUDS registry, wherein said consumer computer is communicating with said service provider computing system, wherein said consumer computer transmits an order request to said service provider computing system, wherein said NSUDS computing system is independent from said service provider computing system and said consumer computer;
verifying, by said computer processor in response to said request, that said service provider computing system is associated with said NSUDS registry;
connecting, by said computer processor in response to results of said verifying, said NSUDS computing system to said consumer computer;
presenting, by said computer processor in response to said connecting, default sensitive user terms associated with sensitive user data for said consumer, wherein said sensitive user data is associated with said order request; and
receiving, by said computer processor from said consumer in response to said default sensitive user terms, a command associated with said default sensitive user terms.

2. The method of claim 1, wherein said command comprises accepting said default sensitive user terms, and wherein said method further comprises:
receiving, by said computer processor from said consumer, said sensitive user data;
transmitting, by said computer processor to said service provider computing system, authorization for completing said order request resulting in a completed order for a product or service for said consumer.

3. The method of claim 2, wherein said authorization includes a payment for said product or service and a physical address for said consumer.

4. The method of claim 1, wherein said command comprises declining said default sensitive user terms, and wherein said method further comprises:
terminating, by said computer processor from said consumer, a connection between said NSUDS computing system and said consumer computer.

5. The method of claim 1, wherein said command comprises a negotiation command for negotiating said default sensitive user terms, and wherein said method further comprises:
receiving, by said computer processor from said consumer, selections for modified sensitive user terms associated with said default sensitive user terms; and
determining, by said computer processor, if said modified sensitive user terms are acceptable with said service provider and are in accordance with specified regulations.

6. The method of claim 5, wherein results of said determining indicate that said modified sensitive user terms are acceptable with said service provider and are in accordance with said specified regulations, and wherein said method further comprises:
modifying, by said computer processor, said default sensitive user terms, wherein said modifying said default sensitive user terms comprises replacing at least one of said default sensitive user terms with at least one of said modified sensitive user terms;
receiving, by said computer processor from said consumer, said sensitive user data;
transmitting, by said computer processor to said service provider computing system, authorization for completing said order request resulting in a completed order for a product or service for said consumer.

7. The method of claim 6, wherein said specified regulations comprise regulations selected from the group consisting of vendor preference regulations, fulfillment requirements regulations, environmental/legal regulations, and government regulations.

8. The method of claim 5, wherein results of said determining indicate that said modified sensitive user terms are not acceptable with said service provider and are not in accordance with said specified regulations, and wherein said method further comprises:
denying, by said computer processor, changes to said default sensitive user terms, wherein said denying changes to said default sensitive user terms comprises disabling said modified sensitive user terms;
generating, by said computer processor, a new sensitive user terms request for said consumer;
transmitting, by said computer processor to said consumer, said new sensitive user terms request; and
receiving, by said computer processor from said consumer in response to said new sensitive user terms request, new selections for new modified sensitive user terms associated with said default sensitive user terms.

9. The method of claim 1, further comprising:
before said presenting said default sensitive user terms, generating by said computer processor, said default sensitive user terms.

10. The method of claim 1, wherein said default sensitive user terms comprise retention periods for storing said sensitive user data.

11. The method of claim 1, wherein said sensitive user data comprises consumer data selected from the group consisting of a consumer name, a consumer address, a consumer telephone number, a consumer email address, a consumer credit card number, and a consumer security code for said credit card number.

12. The method of claim 1, further comprising:
providing at least one support service for at least one of creating, integrating, hosting, maintaining, and deploying computer-readable code in said computing system, wherein the code in combination with the computing system is capable of performing: said receiving said request, said verifying, said connecting, said presenting, and said receiving said command.

13. The method of claim 1, further comprising:
providing a computer program product, comprising a computer storage medium comprising a computer readable program code embodied therein, wherein said computer readable program code is configured to perform: said receiving said request, said verifying, said connecting, said presenting, and said receiving said command.

14. A negotiable content sensitive user service (NSUDS) computing system comprising a computer processor coupled to a computer-readable memory unit, said memory unit comprising instructions that when enabled by the computer processor implement a sensitive user method, said method comprising:
receiving, by said computer processor from a consumer accessing a consumer computer, a request for verifying if a service provider computing system is associated with an NSUDS registry, wherein said consumer computer is communicating with said service provider computing system, wherein said consumer computer transmits an order request to said service provider computing system, wherein said NSUDS computing system is independent from said service provider computing system and said consumer computer;
verifying, by said computer processor in response to said request, that said service provider computing system is associated with said NSUDS registry;
connecting, by said computer processor in response to results of said verifying, said NSUDS computing system to said consumer computer;
presenting, by said computer processor in response to said connecting, default sensitive user terms associated with sensitive user data for said consumer, wherein said sensitive user data is associated with said order request; and
receiving, by said computer processor from said consumer in response to said default sensitive user terms, a command associated with said default sensitive user terms.

15. The computing system of claim 14, wherein said command comprises accepting said default sensitive user terms, and wherein said method further comprises:
receiving, by said computer processor from said consumer, said sensitive user data;
transmitting, by said computer processor to said service provider computing system, authorization for completing said order request resulting in a completed order for a product or service for said consumer.

16. The computing system of claim 15, wherein said authorization includes a payment for said product or service and a physical address for said consumer.

17. The computing system of claim 14, wherein said command comprises declining said default sensitive user terms, and wherein said method further comprises:
terminating, by said computer processor from said consumer, a connection between said NSUDS computing system and said consumer computer.

18. The computing system of claim 14, wherein said command comprises a negotiation command for negotiating said default sensitive user terms, and wherein said method further comprises:
receiving, by said computer processor from said consumer, selections for modified sensitive user terms associated with said default sensitive user terms; and
determining, by said computer processor, if said modified sensitive user terms are acceptable with said service provider and are in accordance with specified regulations.

19. The computing system of claim 18, wherein results of said determining indicate that said modified sensitive user terms are acceptable with said service provider and are in accordance with said specified regulations, and wherein said method further comprises:
modifying, by said computer processor, said default sensitive user terms, wherein said modifying said default sensitive user terms comprises replacing at least one of said default sensitive user terms with at least one of said modified sensitive user terms;
receiving, by said computer processor from said consumer, said sensitive user data;
transmitting, by said computer processor to said service provider computing system, authorization for completing said order request resulting in a completed order for a product or service for said consumer.

20. The computing system of claim 19, wherein said specified regulations comprise regulations selected from the group consisting of vendor preference regulations, fulfillment requirements regulations, environmental/legal regulations, and government regulations.
